(19) United States
(12) Patent Application Publication
(10) Pub. No.: US 2015/0244481 A1
(43) Pub. Date: Aug. 27, 2015

(54) BROADCAST RETRANSMISSION

(71) Applicant: Cambridge Silicon Radio Limited, Cambridge (GB)

(72) Inventors: Hugo Mark Tyson, Cambridge (GB); Nicolas Guy Albert Graube, Barrington (GB); Robin Heydon, Cottenham (GB)

(73) Assignee: Cambridge Silicon Radio Limited, Cambridge (GB)

(21) Appl. No.: 14/297,246

(22) Filed: Jun. 5, 2014

(30) Foreign Application Priority Data
Feb. 26, 2014 (GB) 1403314.6

(51) Int. Cl. H04H 20/71

(52) U.S. Cl. CPC H04H 20/71; H04W 84/18

(57) ABSTRACT

A wireless communication device configured to receive a first data packet identified as being of a broadcast packet type, the first packet comprising a first mesh network data packet that comprises a payload and a first lifetime value. A portion of the first packet may be compared against a record of mesh network data packets previously received by the device. If the record indicates that the first packet has not been previously received by the device and if the first lifetime value of the first packet is not equal to a predetermined threshold value, then form a second mesh network data packet that is unaltered from the first packet except that the first lifetime value is changed to indicate that the first packet has been received. The second packet may be transmitted within a second data packet that is identified as being of the broadcast packet type.

### TECHNICAL FIELD

This invention relates to a communication device that is capable of using a broadcast channel for transmission of transport layer packets.

### BACKGROUND

There is an increasing need for a variety of objects to be equipped with the ability to send and receive messages. In the case of a home, for example, it may be desirable that the objects in a room be capable of communicating with each other, and also potentially being able to communicate with the internet or cloud. For example, the room may have a light, light switch, window and door. It may be desirable that each of these objects be able to communicate with the others so that the home can be automated. Thus, certain actions may be undertaken by one or more of these objects in response to other objects communicating that they are in a particular state. A basic example may be adjusting the heating within a room when the light is switched on, to keep the room at a comfortable temperature. Similar situations are envisaged in a commercial environment.

To enable objects to communicate, they may be equipped with a device that can communicate with similar devices attached to other objects. For this to be useful, a large number of objects may need to be able to communicate with each other. The result can be a network of devices and so this network may potentially have a large number of objects. As many of these objects may not have access to, or require power themselves, for example, packages sitting on a shelf, a window or a door, it may be desirable for the devices that communicate on the objects' behalf to be battery-powered devices that consume only a small amount of power. It may also be desirable that these devices be able to communicate wirelessly with each other so that there is no need for cables running between them.

As the devices are low power, and attached to objects that may be spread over large distances as compared to the transmit and/or receive ranges of the devices, an individual device may not be within communication range of all other devices in the network. This is because the transmission power of the devices may be low, so the radio transmissions by the device may not propagate over a large distance whilst still being decodable.

One suitable method of communication for such a network is to use a mesh networking protocol. This permits a first device to send a message to a second device, which may be outside the communication range of the first device, by transmitting the message via one or more intermediate devices. Historically, mesh networking protocols are typically designed around the concept of devices sending messages using complex routing tables. Such complex routing requires processing power which tends to increase power consumption of the devices. Such mesh networking protocols also tend to operate according to proprietary protocols. This means devices have to be manufactured specifically for the task of communicating according to a particular mesh network. This is often undesirable because it increases the cost of devices that might be installed in a multitude locations and/or attached to a multitude of different devices.

There are communication protocols that are designed to work on low power devices. One such communication protocol is the Bluetooth communication protocol. Existing Bluetooth networks are based around a piconet of devices, with a single master and one or more slaves. Each slave device communicates only with the master, and cannot have direct slave to slave communication. A piconet has to be established before devices can communicate directly with each other. Such a configuration means that, at worst, a separate piconet would need to be established for each communicating device. Such a configuration would be prohibitively complex. This makes a standard Bluetooth connection unsuitable for use in a mesh network. A related communication protocol is the Bluetooth low energy protocol. This does allow for the broadcast of data using an “advertise message”. However, the advertise messages of the Bluetooth low energy protocol are still short-range direct messages designed to enable establishment of a point-to-point connection, which is often undesirable when attempting to establish a Mesh network where some devices in the network may not be in direct contact with others of the devices.

Therefore, there is a need for an improved communication device that is capable of communicating within a mesh network in a simple and power efficient manner.

### SUMMARY

According to a first aspect of the present invention there is provided a wireless communication device capable of operating according to a wireless communications protocol, which defines a broadcast packet type, and capable of communicating in a mesh network, the wireless communication device being configured to: receive a first data packet identified as being of the broadcast packet type, the first data packet comprising a first mesh network data packet that comprises a payload and a first lifetime value; compare at least a portion of the first mesh network data packet against a record of mesh network data packets previously received by the wireless communication device; and if the record indicates that the first mesh network data packet has not been previously received by the wireless communication device and if the first lifetime value of the first mesh network data packet is not equal to a predetermined threshold value: form a second mesh network data packet that is unaltered from the first mesh network data packet except that the first lifetime value is changed to indicate that the first mesh network data packet has been received; and transmit the second mesh network data packet within a second data packet that is identified as being of the broadcast packet type.

The communications protocol may define that no response should be sent in response to the reception of a packet identified as having the broadcast packet type. The predetermined threshold value may be defined in the first data packet.

The predetermined threshold value may be stored by the wireless communication device. The wireless communication device may be configured to change the first lifetime value by decrementing or incrementing it by a predetermined amount. The predetermined threshold value may be zero and the wireless communication device may be configured to form a second mesh network data packet that is unaltered from the first mesh network data packet except for the lifetime value being changed to indicate that it has been received by decrementing the first lifetime value by one.

The predetermined threshold value may be greater than zero and the wireless communication device may be configured to form a second mesh network data packet that is unaltered from the first mesh network data packet except for the lifetime value being changed to indicate that it has been received by incrementing the first lifetime value by one.

The wireless communications device may be configured to, if the first lifetime value of the first mesh network data packet is equal to a predetermined threshold value; not retransmit the data contained within the first mesh network data packet. The wireless communication device may be configured to extract first message data from the first mesh network data packet. The wireless communication device may be configured to compare a portion of the first mesh network data packet that does not include the first lifetime value with the record.

The wireless communication device may be configured to generate the record by storing a portion of previously received mesh network data packets. The wireless communication device may be configured to generate the record by storing an identifier associated with previously received mesh network data packets.

The broadcast packet type may be an advertising channel packet type. The wireless communications protocol may define a data packet type. The wireless communications protocol may be Bluetooth Low Energy protocol. The broadcast packet type may be a non-connectable undirected advertising packet type.

At least some devices within the mesh network may be sited at locations that are out of range of transmissions from the wireless communication device. The mesh network may be an ad-hoc network.

According to a second aspect of the present invention there is provided a wireless communication device capable of operating according to a wireless communications protocol, which defines a broadcast packet type and capable of communicating in a mesh network, the wireless communication device being configured to: receive a first data packet identified as being of the broadcast packet type, the first data packet comprising a first mesh network data packet that comprises a first lifetime value; and if the first lifetime value of the first mesh network data packet is not equal to a predetermined threshold value: form a second mesh network data packet that is unaltered from the first mesh network data packet except that the first lifetime value is changed to indicate that the first mesh network data packet has been received; and transmit the second mesh network data packet within a second data packet that is identified as being of the broadcast packet type.

According to a third aspect of the present invention there is provided a method for communicating within a mesh network, comprising: receiving a first data packet identified as being of a broadcast packet type according to a wireless communications protocol, the first data packet comprising a first mesh network data packet that comprises a payload and a first lifetime value; comparing at least a portion of the first mesh network data packet against a record of mesh network data packets previously received by the wireless communication device; and if the record indicates that the first mesh network data packet has not been previously received by the wireless communication device and if the first lifetime value of the first mesh network data packet is not equal to a predetermined threshold value: forming a second mesh network data packet that is unaltered from the first mesh network data packet except that the first lifetime value is changed to indicate that the first mesh network data packet has been received; and transmitting the second mesh network data packet within a second data packet that is identified as being of the broadcast packet type.

According to a fourth aspect of the present invention there is provided a method for communicating within a mesh network, comprising: receiving a first data packet identified as being of the broadcast packet type according to a wireless communications protocol, the first data packet comprising a first mesh network data packet that comprises a first lifetime value; and if the first lifetime value of the first mesh network data packet is not equal to a predetermined threshold value: forming a second mesh network data packet that is unaltered from the first mesh network data packet except that the first lifetime value is changed to indicate that the first mesh network data packet has been received; and transmit the second mesh network data packet within a second data packet that is identified as being of the broadcast packet type.

### BRIEF DESCRIPTION OF THE DRAWINGS

The present invention will now be described by way of example with reference to the accompanying drawings. In the drawings:

FIG. 1 shows a schematic diagram of a wireless communication device;

FIG. 2 shows a schematic diagram of a network containing a plurality of wireless communication devices;

FIG. 3 illustrates the packet format of the bearer protocol within the network; and

FIG. 4 illustrates the packet format of the transport protocol within the network.

### DETAILED DESCRIPTION

The following description is presented to enable any person skilled in the art to make and use the invention, and is provided in the context of a particular application. Various modifications to the disclosed embodiments will be readily apparent to those skilled in the art.

The general principles defined herein may be applied to other embodiments and applications without departing from the spirit and scope of the present invention. Thus, the present invention is not intended to be limited to the embodiments shown, but is to be accorded the widest scope consistent with the principles and features disclosed herein.

The present invention relates to a wireless communication device that is capable of using a broadcast channel to transmit transport layer data packets. The wireless communication device operates according to a wireless communication protocol. This wireless communication protocol defines a broadcast packet type. The broadcast packet type is not defined by the protocol as being addressed to any one particular device. This is because the broadcast packet type is transmitted according to a wireless communication protocol that is blind to the existence of the network structure that is present at the transport layer within the mesh network.

The wireless communication device is also part of a mesh network. The mesh network is not defined by the wireless communication protocol. The wireless communication device uses the broadcast packet type according to the wireless communication protocol to send mesh network data packets. The mesh network data packets are suitably transport layer data packets. When the wireless communication device receives a data packet of the broadcast packet type, it checks whether the payload includes a mesh data packet. If so, it may check whether the first mesh network data packet has been previously been received by the wireless communication device. If the packet has been previously received by the wireless communication device it can decide not to retransmit the mesh data packet. If the packet has not been previously received by the wireless communication device then, it checks the lifetime value of the mesh data packet to see if it is equal to a predetermined threshold value. If the lifetime value is not equal to the predetermined threshold value, then the device retransmits the mesh data packet is within a broadcast packet type data packet. The only portion of the mesh data packet that is altered is the lifetime value so that it reflects the fact that the packet has been received and retransmitted. If the lifetime value is equal to the predetermined threshold value, however, the communication device does not retransmit the mesh data packet.

The wireless communication device may check the lifetime value of the mesh data packet to see if it is equal to a predetermined threshold value without checking whether the packet has been previously received by the wireless communication device. If the lifetime value is not equal to the predetermined threshold value, then the device retransmits the mesh data packet is within a broadcast packet type data packet. The only portion of the mesh data packet that is altered is the lifetime value so that it reflects the fact that the packet has been received and retransmitted. If the lifetime value is equal to the predetermined threshold value, however, the communication device does not retransmit the mesh data packet.

The wireless communication device can also process the data contained in the mesh data packet to execute any instructions contained in the mesh data packet that are addressed to that particular communication device.

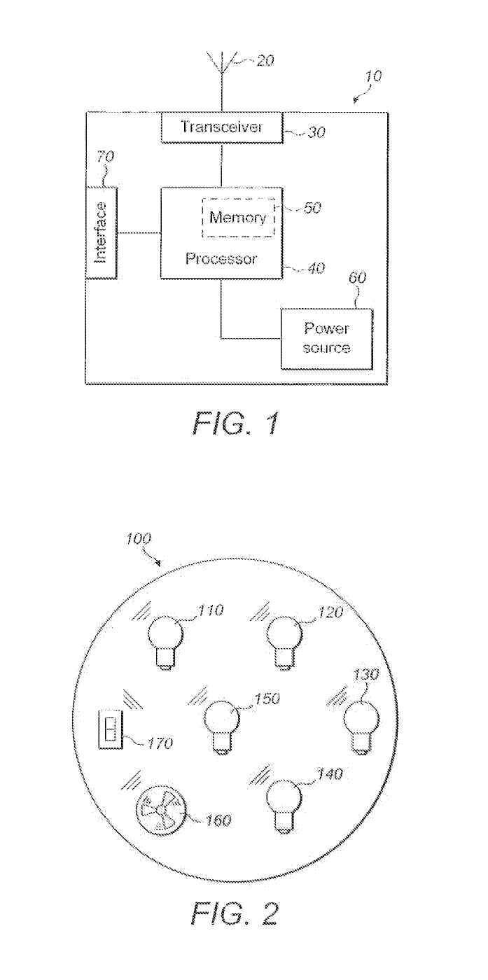

FIG. 1 shows a schematic diagram of an example communication device in accordance with the present invention. In FIG. 1, the communication device 10 has an antenna 20 connected to a transceiver 30. The communication device 10 can use the transceiver to communicate with at least one other communication device according to a communications protocol. The communication device 10 also comprises a processor 40 that is capable of executing a set of program instructions that are stored in a memory 50. The memory 50 can be a non-volatile memory that stores in non-transitory form program code that is executable by the processor 40 to cause the communication device to communicate according to the communications protocol. The processor 40 can be a microprocessor. The memory 50 may be part of processor 40 or connected to processor 40 via a bus. Whilst the processor 40 and transceiver 30 are shown in FIG. 1 as separate elements, it will be appreciated that at least processor 40 and transceiver 30 could be incorporated in to one element. For example, being incorporated on a single chip.

The communication device 10 may also comprise a power source 60. This power source may be a battery. Alternatively, the communication device 10 may not comprise a power source and be connected to an external power source such as an electrical outlet.

The communication device also comprises an interface 70 for sending and receiving data that is to be sent using the communications protocol. This interface 70 may be a wired link to sensors for sensing external events, such as the operation of a light switch in the home environment described above, or a link to appliances for issuing control signals to those appliances, such as the light in the home environment described above.

The communication device described above forms part of a network 100 as shown in FIG. 2. This network comprises a plurality of the communication devices described above in relation to FIG. 1. FIG. 2 shows a plurality of objects each equipped with a communication device as described above to enable the object to communicate over the communications protocol with at least one of the plurality of devices that are part of network 100. This network 100 comprises lights 110, 120, 130, 140, 150, a fan 160 and light switch 170 which are each equipped with a communication device. These objects are given as examples, and it will be readily appreciated that any other object could be equipped with such a communication device for communicating with the other communication devices.

The devices at the extremities of the network 100 may be outside of the communication range of one or more of the other devices. This is because the communication devices attached to the objects are low power communication devices. For example, lights 110 and 150, and fan 160 may be within the direct communication range of light switch 170. However, lights 120, 130 and 140 may be outside of the direct communication range of light switch 170, but within the direct communication range of lights 110 and 150 and fan 160. For light switch 170 to communicate with lights 120, 130 and 140, a communication sent by the light switch 170 is preferably retransmitted by at least one of light 110, light 150 or fan 160. As none of the devices know whether the other devices have received the transmission, they are preferably all configured to retransmit the message.

A suitable method of transmitting a communication from the device associated with light switch 170 to the device associated with light 120 which is outside the direct communication range of light switch device 170 is a mesh network that can use a use flood routing method to propagate information. Flood routing potentially enables every device within the network to receive a copy of a message transmitted within the network either directly (e.g. from light switch device 170, which transmitted the message) or indirectly via another device receiving the message and retransmitting it. There may be some devices do not receive a copy of a message due to being out of range when a copy is sent or by not scanning at the appropriate times. In this way, a message sent by light switch device 170 will eventually reach light switch 120. Using flood routing to communicate a sent message to all communication devices within a network involves (i) a means of broadcasting messages to all devices that are within the communication range of the sending device and (ii) all devices that receive the broadcast messages rebroadcasting it so that it is also received by all devices within their communication range. The actual payload data that is contained within the message that is sent can be unimportant to the flood routing. However, certain elements of the payload data can be used in some of the examples given below.

As discussed above, a common communication protocol for low powered devices is Bluetooth low energy, now marketed as Bluetooth SMART. This protocol is designed to be a point-to-point protocol to enable one device to communicate directly with another device whilst having a low power consumption. Bluetooth low energy does, however, also define a capability to broadcast data using an advertising message. In the current protocol, broadcast data is sent over the advertising channel.

The network shown in FIG. 2 can make use of the broadcast capability of Bluetooth low energy encompassed in the advertising channel to provide the means of broadcasting messages to all devices that are within the communication range of the sending device. This is advantageous because Bluetooth low energy is an established protocol that is already used within many devices. This makes the cost associated with a device that can communicate according to the Bluetooth low energy protocol very low and also provides for a high level of interoperability between devices of different manufacturers.

Whilst the Bluetooth low energy protocol is used in the discussions above and below, it will be apparent that any protocol that contains the same, similar or functionally equivalent features as those discussed in relation to the Bluetooth low energy protocol could be used instead.

The advertising channel within Bluetooth low energy can be used to send a number of different packet types. A receiving device is permitted to send a response to some of these packet types. For example, if the received packet has a type of one of the packet types ADV_IND, ADV_DIRECT_IND and ADV_SCAN_IND, these packet types all permit a response of some type to the received packet. One packet type does not permit any response by a receiving device. This packet type is the ADV_NONCONN_IND packet type. This is known as the non-connectable undirected advertising event type. Such a packet type allows a transmitting device to broadcast data by incorporating the data into its payload. The use of the non-connectable undirected advertising event packet type may be advantageous in a mesh network because no response is permitted or expected when the packet is received. This means that network traffic is kept to a minimum because to make communications that are for the purpose of sending data around the network.

Devices will receive the broadcast data when they are operating in scanning mode. They may be configured to only operate in scanning mode periodically, so as to conserve power.

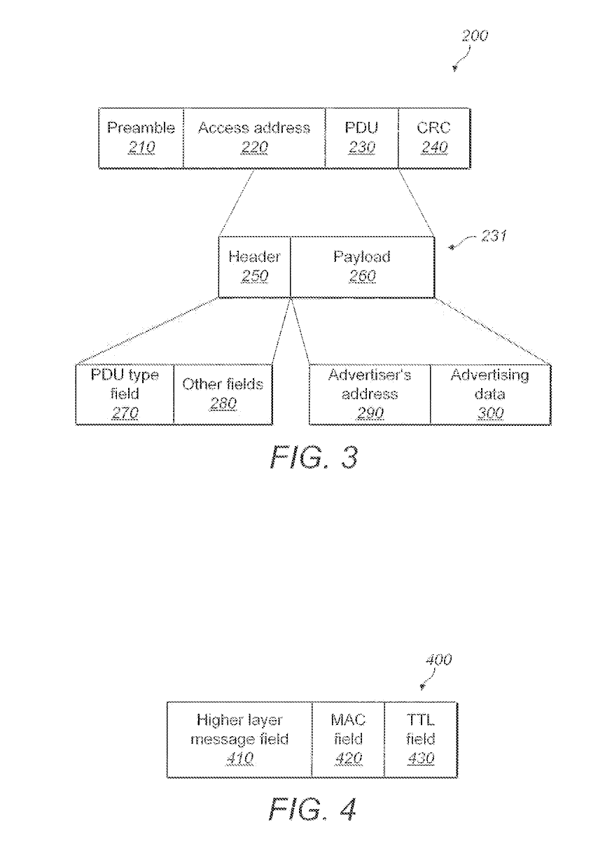

An example, the format of the non-connectable undirected advertising event (NCA) packet type is illustrated in FIG. 3. The general packet 200 has a preamble 210, an access address 220, which in the case of the advertising packet is the same for all advertising channel packets, a protocol data unit (PDU) 230 and a CRC 240. The CRC 240 at the end of the packet may be a 24-bit CRC. In the case of an advertising packet the PDU 230 is an advertising channel PDU. Within Bluetooth low energy the packet that is being transmitted can either be an advertising channel packet or a data channel packet.

If the PDU 230 is an advertising channel PDU 231, it comprises a header 250 and a payload 260. The header contains a PDU Type field 270 together with other fields 280 such as a length field, which indicates the field length of the payload in octets. The PDU Type is set of 0010 to indicate the packet is of ADV_NONCONN_IND packet type.

The payload 260 contains the advertiser's address 290, followed by the advertising data 300. In the case of the network shown in FIG. 2, the section allocated for advertising data 300 will contain the message being sent by a device forming part of the mesh network 100.

In this way the Bluetooth low energy non-connectable undirected advertising packets form the bearer layer for the network shown in FIG. 2. This bearer layer is used to transmit messages to one or more other devices in the mesh network. The Bluetooth low energy protocol also provides for the reception of packets by the devices in the mesh network. This is provided by a scanning mode in which the devices will receive the advertising packets of other devices. Therefore, this bearer layer is also enables the reception of messages sent by a device within the network.

Bluetooth low energy does not, however, provide for the devices that receive the broadcast messages to rebroadcast that message to all devices that are within their communication range. This retransmission is preferably implemented by the devices that are members of the network to provide for transport of data throughout that network. To enable the retransmission of messages within the network 100, the devices within the network 100 are preferably responsive to a mesh transport packet 400 (shown in FIG. 4), which is comprised within a broadcast packet, and which contains the transmitted message. When a device receives the mesh transport packet 400, it is preferably configured to process parts of it to decide whether to retransmit it or not. Retransmitting the packet enables it to be received by more devices within the mesh network 100.

FIG. 4 illustrates the format of the mesh transport packet 400 that may be sent within the payload 300 of a Bluetooth low energy non-connectable undirected advertising packets. The mesh transport packet 400 comprises a higher layer message field 410, a Message Authentication Code (MAC) field 420 and a Time-To-Live (TTL) field 430. The MAC is computed based on the contents of the higher layer message field 410.

The payload of the mesh transport packet 400 can be defined as the higher layer message field 410 and the MAC field 420. The payload of the mesh transport packet 400 can also be described as the static content of the mesh transport packet 400 because it is not altered as it is retransmitted throughout the mesh network 100. The higher layer message field 410 may comprise the ID of the sender (or the sender-ID) and a serial number. The serial number can be unique to that particular sender. The pair of the sender-ID and the serial number uniquely identifies a particular message within the mesh network.

As discussed above, when a device receives the mesh transport packet 400, it is preferably configured to process parts of it to decide whether to retransmit it or not. Retransmitting the packet enables it to be received by more devices within the mesh network 100. However, retransmission of a packet can also cause congestion within the network. Also, the message and/or data within the packet may have an expiry period and so after this period propagation throughout the network is no longer required. Hence, the device preferably being configured to process parts of the mesh transport packet 400 to decide whether to retransmit it.

It can be preferable for the receiving device to determine whether the payload of the mesh transport packet 400 has previously been received by that particular receiving device. If the payload of the mesh transport packet 400 has previously been received by the communication device, then the communication device does not retransmit the packet. If the payload of the mesh transport packet 400 has not previously been received by the communication device 10, then the communication device decides whether to retransmit the packet based on the lifetime field 430 as described below.

The determination whether the payload has previously been received may be achieved by the communication device being configured so that it stores a record of the static content of the mesh transport packet 400. The communication device may be configured to record only a part of the static content of the mesh transport packet 400 or a representation of it. This record can then be compared against a received packet to decide whether to retransmit it. The communication device 10 may be configured to store the record in memory 50.

The record of the static content of the mesh transport packet 400 may comprise:
a record of the whole payload. The payload may comprise the higher layer message field 410 and the MAC field 420. Alternatively, the payload may be the static content of the mesh transport packet 400. The static content of the mesh transport packet 400 may not include the lifetime field 430 which can be changed each time the packet is sent.
a record of the MAC. The MAC is probabilistically likely to be a unique identifier for the payload as a whole.
The ID of the sender (or the sender-ID) and serial number contained within the higher layer message field 410.
Any portion of the static content of the mesh transport packet 400 that is unique to the static content of that particular mesh transport packet 400.

As storage within the communication device 10 may be limited, the record of the static content may be limited in size. Once hill the communication device 10 may be configured to overwrite the oldest entry in the record. The communication device 10 may store the record of the static content in a table.

The Time-To-Live field 430 can more generally be a lifetime field 430 that defines the lifetime of the mesh transport packet 400 within the mesh network. The lifetime field 430 of the mesh transport packet 400 is used by the receiving device to determine whether the received mesh transport packet 400 should be resent over the advertising channel of the Bluetooth low energy protocol or not.

If the lifetime field 430 is equal to a threshold value then the packet is not retransmitted. If the lifetime field 430 is not equal to a threshold value then the packet is retransmitted. If the packet is retransmitted then the higher layer message field 410 and the MAC field 420 are unaltered in the retransmission packet from the received packet. The lifetime field is altered by the retransmitting device to indicate that it has been retransmitted. The lifetime field could contain an integer number that is incremented or decremented by the retransmitting device to indicate that it has been retransmitted. The lifetime field could be incremented or decremented by one. If the contents of the lifetime field is incremented upon retransmission then the stored threshold value will be set equal to or greater than the initial value of the lifetime field 430 as set by the original sending device. Alternatively, if the contents of the lifetime field is decremented upon retransmission then the stored threshold value will be will be set equal to or less than the initial value of the lifetime field 430 as set by the original sending device.

Two examples of how the lifetime field 430 can be used by the receiving device to determine whether the received mesh transport packet 400 should be retransmitted are described below. This is for the purposes of example only, and other implementations are also possible.

In both cases if the lifetime field 430 is equal to a threshold value then the packet is not retransmitted. If the lifetime field 430 is not equal to a threshold value then the packet is retransmitted. If the packet is retransmitted then the higher layer message field 410 and the MAC field 420 are unaltered in the retransmission packet from the received packet. The lifetime field is altered by the retransmitting device to indicate that it has been retransmitted.

A first implementation is for the original sending device to set the lifetime field 430 to a value that is greater than zero. In this case, the lifetime field 430 can also be known as a TTL field 430. If the receiving device receives a mesh transport packet 400 with a TTL value that is greater than zero, the receiving device sets the TTL value to one less than the value of the field in the received message and retransmits the packet. If the receiving device receives a mesh transport packet 400 with a TTL value that is equal to zero the receiving device does not retransmit the packet. In this case, the threshold value may be zero. This implementation has the advantage that no configuration is required to varying thresholds at the receiving devices. For example, if a message has a relatively high priority, so that it is desired for it to be retransmitted a higher number of times than a lower priority message, the TTL value can be set to a higher value initially by the original sending device than the TTL value in a lower priority message.

A second implementation is for the original sending device to set the lifetime field 430 to zero and for each device within the network to store a threshold lifetime value. In this case, the lifetime field can also be known as a Max Hop Count (MHC) field 430 and the threshold lifetime value can be known as a threshold MHC value. If the receiving device receives a mesh transport packet 400 with a MHC value that is less than its stored threshold MHC value, the receiving device sets the MHC value to one more than the value of the field in the received message and retransmits the packet. If the receiving device receives a mesh transport packet 400 with a MHC value that is equal to its stored threshold MHC value, it does not transmit the packet. In this case, the threshold value may be a positive non-zero number.

In the above described configuration, the behaviour of a device upon reception of a mesh transport packet 400 over the advertisement channel, forms the transport layer of the network. The individual devices do not need to process the data contained within the higher layer message 410 to decide whether to retransmit messages within the network and so provide delivery of messages beyond the distance enabled by an individual device.

The above has described the retransmission of the messages by the devices so that the messages are delivered to the whole network. However, when the mesh transport packet 400 is received by an individual device, it will also process the data contained in the mesh transport packet 400 to extract the data contained in the higher layer message field 410. It may be that the communication device 10 will only process the data contained in the mesh transport packet 400 sufficiently so that it can be sent over data interface 70. The object that is connected to data interface 70 may process the data contained in the mesh transport packet 400. Alternatively, the processor 40 of the communication device 10 may process the mesh transport packet 400 to extract the data contained in the higher layer message field 410 of the data packet 400. In this case the processor may interpret the data contained in the higher layer message field 410 and then send instructions over data interface 70 as required by the data contained in the higher layer message field 410.

As discussed above in relation to FIG. 1, this interface 70 may be a wired link to sensors for sensing external events, such as the operation of a light switch in the home environment described above, or a link to appliances for issuing control signals to those appliances, such as the light in the home environment described above. And so the communication device 10 may issue a control signal to an appliance on the basis of the data contained in higher layer message field 410.

The applicant hereby discloses in isolation each individual feature described herein and any combination of two or more such features, to the extent that such features or combinations are capable of being carried out based on the present specification as a whole in the light of the common general knowledge of a person skilled in the art, irrespective of whether such features or combinations of features solve any problems disclosed herein, and without limitation to the scope of the claims. The applicant indicates that aspects of the present invention may consist of any such individual feature or combination of features. In view of the foregoing description it will be evident to a person skilled in the art that various modifications may be made within the scope of the invention.

What is claimed is:

1. A wireless communication device capable of operating according to a wireless communications protocol, which defines a broadcast packet type, and capable of communicating in a mesh network, the wireless communication device being configured to:
receive a first data packet identified as being of the broadcast packet type, the first data packet comprising a first mesh network data packet that comprises a payload and a first lifetime value;
compare at least a portion of the first mesh network data packet against a record of mesh network data packets previously received by the wireless communication device; and
if the record indicates that the first mesh network data packet has not been previously received by the wireless communication device and if the first lifetime value of the first mesh network data packet is not equal to a predetermined threshold value:
form a second mesh network data packet that is unaltered from the first mesh network data packet except that the first lifetime value is changed to indicate that the first mesh network data packet has been received; and
transmit the second mesh network data packet within a second data packet that is identified as being of the broadcast packet type.

2. A wireless communication device as claimed in claim 1, wherein the communications protocol defines that no response should be sent in response to the reception of a packet identified as having the broadcast packet type.

3. A wireless communication device as claimed in claim 1, wherein the predetermined threshold value is defined in the first data packet.

4. A wireless communication device as claimed in claim 1, wherein the predetermined threshold value is stored by the wireless communication device.

5. A wireless communication device as claimed in claim 1, the wireless communication device being configured to change the first lifetime value by decrementing or incrementing it by a predetermined amount.

6. A wireless communication device as claimed in claim 1, wherein the predetermined threshold value is zero and the wireless communication device is configured to form a second mesh network data packet that is unaltered from the first mesh network data packet except for the lifetime value being changed to indicate that it has been received by decrementing the first lifetime value by one.

7. A wireless communication device as claimed in claim 1, wherein the predetermined threshold value is greater than zero and the wireless communication device is configured to form a second mesh network data packet that is unaltered from the first mesh network data packet except for the lifetime value being changed to indicate that it has been received by incrementing the first lifetime value by one.

8. A wireless communication device as claimed in claim 1, the wireless communications device being configured to, if the first lifetime value of the first mesh network data packet is equal to a predetermined threshold value: not retransmit the data contained within the first mesh network data packet.

9. A wireless communication device as claimed in claim 1, the wireless communication device being configured to extract first message data from the first mesh network data packet.

10. A wireless communication device as claimed in claim 1, the wireless communication device is configured to compare a portion of the first mesh network data packet that does not include the first lifetime value with the record.

11. A wireless communication device as claimed in claim 1, the wireless communication device is configured to generate the record by storing a portion of previously received mesh network data packets.

12. A wireless communication device as claimed in claim 1, the wireless communication device is configured to generate the record by storing a identifier associated with previously received mesh network data packets.

13. A wireless communication device as claimed in claim 1, wherein the broadcast packet type is an advertising channel packet type.

14. A wireless communication device as claimed in claim 1, wherein the wireless communications protocol defines a data packet type.

15. A wireless communication device as claimed in claim 1, wherein the wireless communications protocol is Bluetooth Low Energy protocol.

16. A wireless communication device as claimed in claim 15, wherein the broadcast packet type is a non-connectable undirected advertising packet type.

17. A wireless communication device as claimed in claim 1, wherein at least some devices within the mesh network are sited at locations that are out of range of transmissions from the wireless communication device.

18. A wireless communication device as claimed in claim 1, wherein the mesh network is an ad-hoc network.

19. A wireless communication device capable of operating according to a wireless communications protocol, which defines a broadcast packet type and capable of communicating in a mesh network, the wireless communication device being configured to:
receive a first data packet identified as being of the broadcast packet type, the first data packet comprising a first mesh network data packet that comprises a first lifetime value; and
if the first lifetime value of the first mesh network data packet is not equal to a predetermined threshold value: form a second mesh network data packet that is unaltered from the first mesh network data packet except that the first lifetime value is changed to indicate that the first mesh network data packet has been received; and transmit the second mesh network data packet within a second data packet that is identified as being of the broadcast packet type.

20. A method for communicating within a mesh network, comprising:
receiving a first data packet identified as being of a broadcast packet type according to a wireless communications protocol, the first data packet comprising a first mesh network data packet that comprises a payload and a first lifetime value;
comparing at least a portion of the first mesh network data packet against a record of mesh network data packets previously received by the wireless communication device; and
if the record indicates that the first mesh network data packet has not been previously received by the wireless communication device and if the first lifetime value of the first mesh network data packet is not equal to a predetermined threshold value:
forming a second mesh network data packet that is unaltered from the first mesh network data packet except that the first lifetime value is changed to indicate that the first mesh network data packet has been received; and
transmitting the second mesh network data packet within a second data packet that is identified as being of the broadcast packet type.
